(19) United States
(12) Patent Application Publication
(10) Pub. No.: US 2019/0253619 A1
(43) Pub. Date: Aug. 15, 2019

(54) MEDIA CAPTURE LOCK AFFORDANCE FOR GRAPHICAL USER INTERFACE

(71) Applicant: Apple Inc., Cupertino, CA (US)

(72) Inventors: Anton M. Davydov, Gilroy, CA (US); Daniel J. Wiersema, San Jose, CA (US); Jane E. Koo, Santa Clara, CA (US)

(73) Assignee: Apple Inc., Cupertino, CA (US)

(21) Appl. No.: 15/995,040

(22) Filed: May 31, 2018

Related U.S. Application Data
(60) Provisional application No. 62/628,825, filed on Feb. 9, 2018.

(51) Int. Cl. H04N 5/232; G06F 3/0488

(52) U.S. Cl. CPC H04N 5/23225; G06F 3/04883

(57) ABSTRACT

The disclosed embodiments are directed to a media capture lock affordance for a graphical user interface displayed by a media capture device. The media capture lock affordance allows a user to lock and unlock a capture state of the media capture device using a simple and intuitive touch gesture that can be applied by the user's finger (e.g., the user's thumb) while holding the media capture device in one hand.

### CROSS-RELATED APPLICATION

This application claims the benefit of priority from U.S. Provisional Patent Application No. 62/628,825 for “Media Capture Lock Affordance for Graphical User Interface, filed Feb. 9, 2018, which provisional patent application is incorporated by reference herein in its entirety.

### TECHNICAL FIELD

This disclosure relates generally to graphical user interfaces for media capture applications.

### BACKGROUND

Media capture devices (e.g., smart phones, tablet computers), include applications that allow users to record media clips (e.g., video clips, audio clips) using one or more embedded cameras and microphones. The user holds down a virtual record button to capture a media clip. Once the user is done recording, the user can drag the media clip into a desired order with other media clips and add filters, emoji, animated icons and titles. Media clips can be shared indirectly through social networks and/or sent directly to friends through, for example, instant messaging applications.

### SUMMARY

The disclosed embodiments are directed to a media capture lock affordance for a graphical user interface. In an embodiment, a method of capturing media comprising: detecting, by a media capture device, a tap and hold gesture input directed to a media capture affordance displayed at a first location on a graphical user interface presented on a display screen of the media capture device; responsive to the tap and hold gesture input, initiating, by the image capture device, a media capture session on the media capture device in an unlocked state; responsive to the media capture device detecting a first lift gesture in which the tap and hold gesture input lifts from the first location on the graphical user interface during the media capture session, terminating, by the image capture device, the media capture session; responsive to the media capture device detecting a slide gesture input in which the media capture affordance slides from the first location to a second location on the graphical user interface during the media capture session, changing, by the media capture device, the media capture affordance to a media capture lock affordance; and responsive to the media capture device detecting a second lift gesture in which the slide gesture input lifts from the graphical user interface at the second location during the media capture session, transitioning, by the media capture device, the media capture session into a locked state.

Other embodiments can include an apparatus, computing device and non-transitory, computer-readable storage medium.

Particular embodiments disclosed herein may provide one or more of the following advantages. A media capture lock affordance allows a user to lock and unlock a capture state of a media capture device using a simple and intuitive touch gesture that can be applied by the user's finger (e.g., the user's thumb) while holding the media capture device in one hand.

The details of one or more implementations of the subject matter are set forth in the accompanying drawings and the description below. Other features, aspects and advantages of the subject matter will become apparent from the description, the drawings and the claims.

### BRIEF DESCRIPTION OF THE DRAWINGS

FIGS. 1A-1H illustrate operation of a media capture lock affordance, according to an embodiment.

FIG. 2 is a flow diagram of an animation process for the media capture lock affordance shown in FIGS. 1A-1H, according to an embodiment.

FIG. 3 illustrates an example device architecture of a media capture device implementing the media capture lock affordance described in reference to FIGS. 1-2, according to an embodiment.

### DETAILED DESCRIPTION

### Example Media Lock Affordance

This disclosure relates to media recording functionality of a media capture device that locks a media capture affordance on a graphical user interface (GUI) into a locked media capture state for continuous media capture. In an embodiment, to initiate a media capture session of a media clip (e.g., a video clip, audio clip), the user taps and holds the media capture affordance (e.g., a virtual recording button). As long as the user holds their touch on the media capture affordance, the media continues to be captured by the media capture device. If the user removes their touch during the media capture session, the media capture session terminates. If the user maintains their touch on the media capture affordance while making a sliding gesture with their finger, the media capture affordance visually changes to a locked media capture affordance and the media capture session is maintained, resulting in continuous recording of the media. In an embodiment, the locked media capture affordance moves down below the user's finger so that it is not obscured by the user's finger. The user can remove their finger from the locked media capture affordance and the media capture session will be maintained until the user taps the locked state capture button, which then terminates the media capture session.

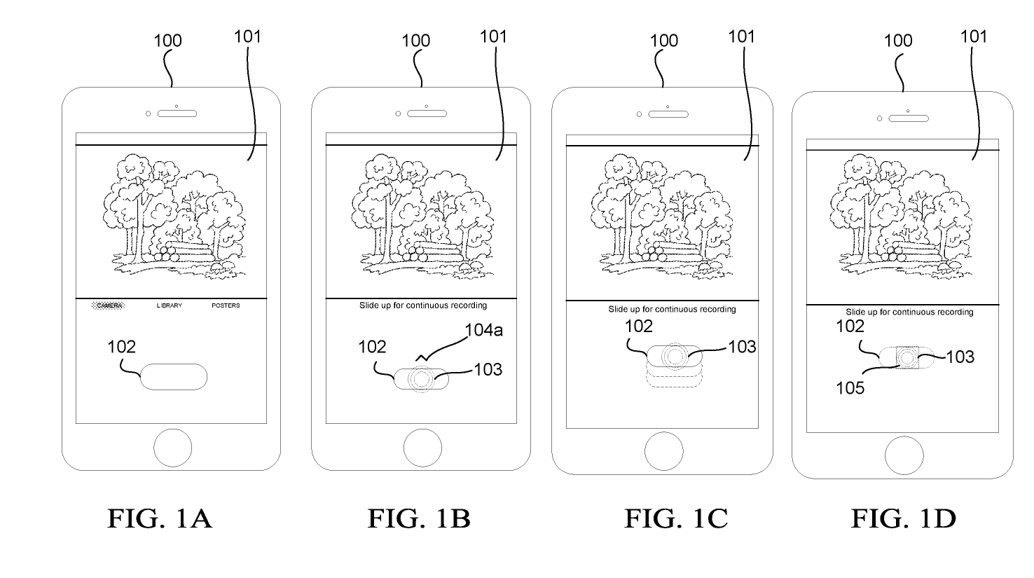

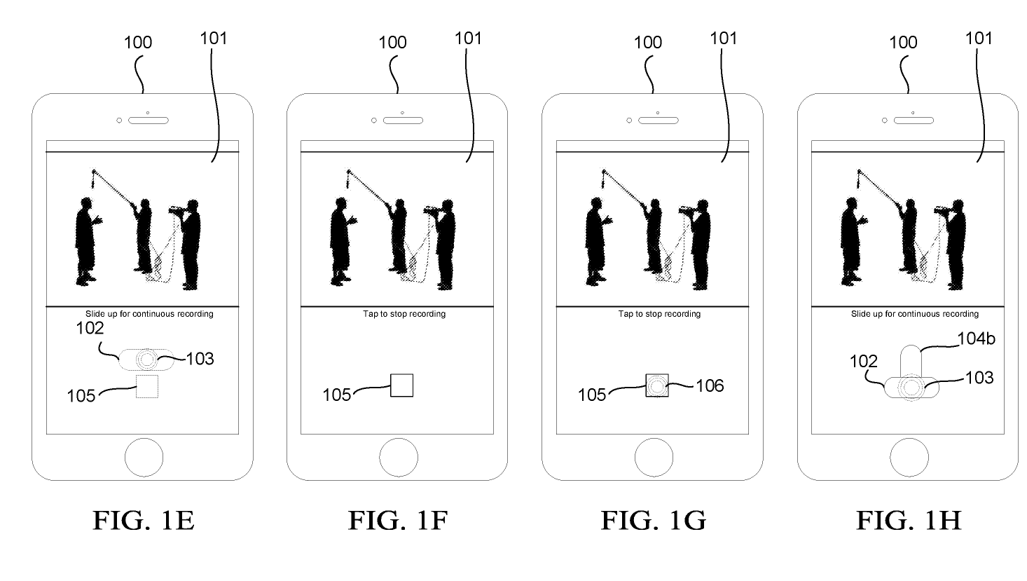

FIGS. 1A-1H illustrate operation of a media capture lock affordance, according to an embodiment. Referring to FIG. 1A, media capture device 100 is presenting GUI 101 on a display screen. GUI 101 includes media capture affordance 102. Media capture device 100 is shown in this example embodiment as a smartphone. Media capture device 100, however, can be any electronic device capable of capturing media, including tablet computers, wearable computers, digital cameras, video recorders and audio recording devices. Media capture affordance 102 can have any desired shape, size or color. In the example shown, media capture affordance 102 is an oval shape button. GUI 101 also includes a display area for displaying live media and playing back captured media. Media can be any type of media that can be captured, including video, still images and audio or any combination thereof.

Referring to FIG. 1B, a user taps and holds 103 (shown as a dashed circle) media capture affordance 102 with their finger (e.g., their thumb while holding media capture device 100) to initiate a media capture session in an “unlocked” state. During the media capture session, an embedded video camera and/or one or more microphones capture media (e.g., capture video and audio). The media capture session is “unlocked” meaning that if the user lifts their finger from media capture affordance 102 (lifts their finger off the display screen), the media capture session terminates, and the media is stored on media capture device 100 (e.g., stored in cache memory). Visual direction indicator 104a (e.g., an arrow head) is displayed on GUI 101 to indicate a direction in which the user may slide their finger to transition the media capture session into a “locked” state. While in the “locked” state, the media is continuously captured without interruption. For example, video and audio will continue to record and still images will be taken in “burst” mode. Text is also displayed on GUI 101 that instructs the user to “slide up for continuous recording.”

In some embodiments, additional affordances (not shown) are included on GUI 101 for allowing the user to playback the captured media (hereinafter also referred to as a “media clip”), and order, filter, add emoji, animated icons and titles to the media clip. Other affordances allow the user to share the media clips indirectly with social networking websites and directly with friends and family through various communication means (e.g., instant messaging, email, tweeting). In the embodiment shown, a navigation bar is located under the media display area that allows the user select an operation mode such as Camera, Library and Posters.

Referring to FIG. 1C, shows the user's slide gesture input resulting in media capture affordance 102 sliding up toward the media capture area. Note that during a slide gesture input the user's finger does not break contact with the display screen.

Referring to FIGS. 1D-1G, when the user slide media capture affordance 102 up a predetermined distance, media capture affordance 102 changes or morphs into media capture lock affordance 105 to visually indicate a “locked” state, as shown in FIG. 1F. The text below the media display area also changes to instruct the user how to exit the “locked” state such as, for example, “tap to stop recording.” Media capture lock affordance 105 can be any size, shape or color. In the example shown, media capture lock affordance 105 is a square button. After the change or morph from media capture affordance 102 to media capture lock affordance 105, if the user lifts their finger and breaks contact with the display screen, the media capture session enters the “locked” state. In the “locked” state the media capture session continues with the media capture until the user taps 106 media capture lock affordance 105 (FIG. 1G), in which case the media capture session terminates. In an alternative embodiment, visual direction indicator 104a can be replaced with button track 104b to show the user the distance the user should slide media capture affordance 102 to enter the “locked” state.

In other embodiments, multiple taps can be used instead of a single tap. The direction of the slide gesture input can be in any direction on GUI 101, including up, down, right and left. A sound effect can be played in sync with the tap and slide gesture, such as a “click” sound effect to indicate when the media capture session is locked and unlocked. In an embodiment, force feedback (e.g., a vibration) can be provided by a haptic engine to indicate when the media capture session is locked and unlocked. Affordances 102, 106 can be placed at any desired location on GUI 101, and can change location, size and/or shape in response to the orientation of media capture device 100, such as portrait and landscape orientations. In an embodiment, the user can enter or exit a locked media capture state using a voice command, which is processed by a speech detection/recognition engine implemented in media capture device 100.

### Example Processes

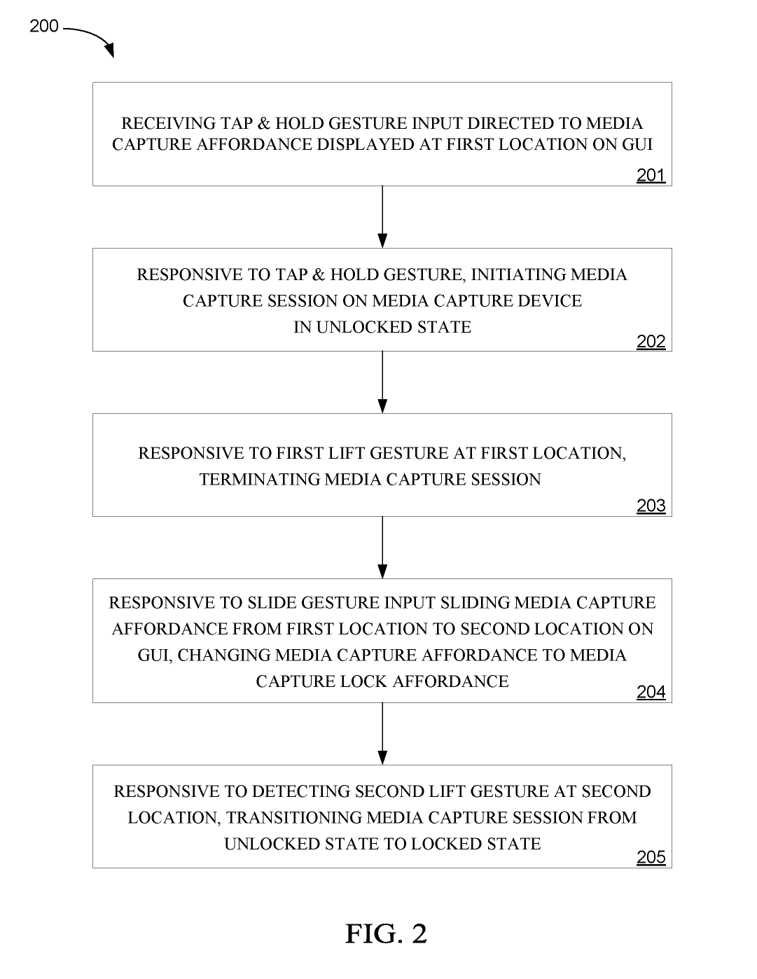

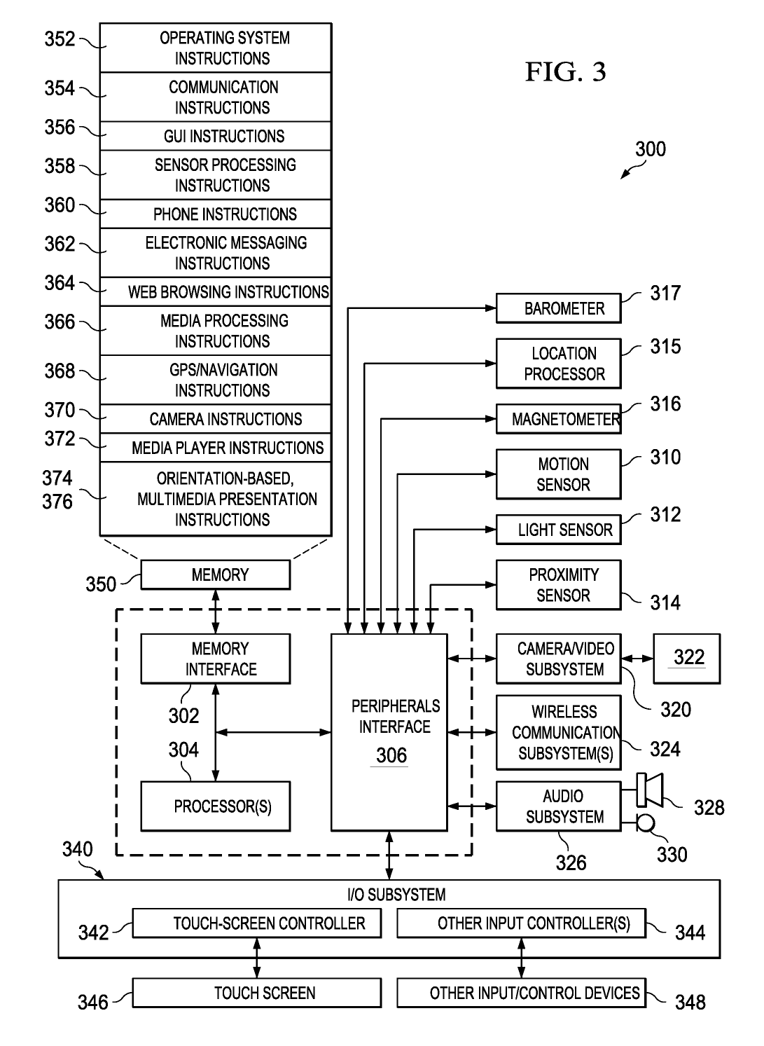

FIG. 2 is a flow diagram of an animation process for the media capture lock affordance shown in FIGS. 1A-1H, according to an embodiment. Process 200 can be implemented using the device architecture 300 described in reference to FIG. 3.

Process 200 begins by receiving a tap and hold gesture input directed to a media capture affordance at a first location of a GUI presented on a display device of a media capture device (201). The media capture affordance can be and size, shape or color. The first location can be any desired location on the GUI. Responsive to the tap and hold gesture input, process 200 initiates a media capture session on the media capture device, where the media capture session is initiated in an “unlocked” state (202). Responsive to a first lift gesture at the first location, process 200 terminates the media capture session (203).

Responsive to a slide gesture input from the first location to a second location on the GUI, process 200 changes the media capture affordance to a media capture lock affordance (204). The media capture lock affordance can be any size, shape or color. The second location can be any desired location on the GUI except the first location. The slide gesture can be in any desired direction including up, down, left and right.

Responsive to detecting a second lift gesture at the second location, process 200 transitions the media capture session from an unlocked state into a locked state (205). In a locked state, the media capture device will capture media continuously, until the user taps the media capture lock affordance to terminate the media capture session. In an embodiment, the user can tap anywhere on the GUI to terminate the media capture session after the second lift gesture, or press a mechanical button on the media capture device (e.g., a home button on a smartphone).

### Exemplary Mobile Device Architecture

FIG. 3 illustrates an example media capture device architecture 300 of a mobile device implementing the media capture lock affordance described in reference to FIGS. 1 and 2. Architecture 300 can include memory interface 302, one or more data processors, image processors and/or processors 304 and peripherals interface 306. Memory interface 302, one or more processors 304 and/or peripherals interface 306 can be separate components or can be integrated in one or more integrated circuits. The various components in architecture 300 can be coupled by one or more communication buses or signal lines.

Sensors, devices and subsystems can be coupled to peripherals interface 306 to facilitate multiple functionalities. For example, one or more motion sensors 310, light sensor 312 and proximity sensor 314 can be coupled to peripherals interface 306 to facilitate motion sensing (e.g., acceleration, rotation rates), lighting and proximity functions of the mobile device. Location processor 315 can be connected to peripherals interface 306 to provide geopositioning. In some implementations, location processor 315 can be a GNSS receiver, such as a Global Positioning System (GPS) receiver chip. Electronic magnetometer 316 (e.g., an integrated circuit chip) can also be connected to peripherals interface 306 to provide data that can be used to determine the direction of magnetic North. Electronic magnetometer 316 can provide data to an electronic compass application. Motion sensor(s) 310 can include one or more accelerometers and/or gyros configured to determine change of speed and direction of movement of the mobile device. Barometer 317 can be configured to measure atmospheric pressure around the mobile device.

Camera subsystem 320 and an optical sensor 322, e.g., a charged coupled device (CCD) or a complementary metal-oxide semiconductor (CMOS) optical sensor, can be utilized to facilitate camera functions, such as capturing photographs and recording video clips.

Communication functions can be facilitated through one or more wireless communication subsystems 324, which can include radio frequency (RF) receivers and transmitters (or transceivers) and/or optical (e.g., infrared) receivers and transmitters. The specific design and implementation of the communication subsystem 324 can depend on the communication network(s) over which a mobile device is intended to operate. For example, architecture 300 can include communication subsystems 324 designed to operate over GSM networks, GPRS networks, EDGE networks, a Wi-Fi™ or Wi-Max™ networks and Bluetooth™ networks. In particular, the wireless communication subsystems 324 can include hosting protocols, such that the mobile device can be configured as a base station for other wireless devices.

Audio subsystem 326 can be coupled to a speaker 328 and a microphone 330 to facilitate voice-enabled functions, such as voice recognition, voice replication, digital recording and telephony functions. Audio subsystem 326 can be configured to receive voice commands from the user.

I/O subsystem 340 can include touch surface controller 342 and/or other input controller(s) 344. Touch surface controller 342 can be coupled to a touch surface 346 or pad. Touch surface 346 and touch surface controller 342 can, for example, detect contact and movement or break thereof using any of a plurality of touch sensitivity technologies, including but not limited to capacitive, resistive, infrared and surface acoustic wave technologies, as well as other proximity sensor arrays or other elements for determining one or more points of contact with touch surface 346. Touch surface 346 can include, for example, a touch screen. I/O subsystem 340 can include a haptic engine or device for providing haptic feedback (e.g., vibration) in response to commands from a processor.

Other input controller(s) 344 can be coupled to other input/control devices 348, such as one or more buttons, rocker switches, thumb-wheel, infrared port, USB port and/or a pointer device such as a stylus. The one or more buttons (not shown) can include an up/down button for volume control of speaker 328 and/or microphone 330. Touch surface 346 or other controllers 344 (e.g., a button) can include, or be coupled to, fingerprint identification circuitry for use with a fingerprint authentication application to authenticate a user based on their fingerprint(s).

In one implementation, a pressing of the button for a first duration may disengage a lock of the touch surface 346; and a pressing of the button for a second duration that is longer than the first duration may turn power to the mobile device on or off. The user may be able to customize a functionality of one or more of the buttons. The touch surface 346 can, for example, also be used to implement virtual or soft buttons and/or a virtual touch keyboard.

In some implementations, the mobile device can present recorded audio and/or video files, such as MP3, AAC and MPEG files. In some implementations, the mobile device can include the functionality of an MP3 player. Other input/output and control devices can also be used.

Memory interface 302 can be coupled to memory 350. Memory 350 can include high-speed random access memory and/or non-volatile memory, such as one or more magnetic disk storage devices, one or more optical storage devices and/or flash memory (e.g., NAND, NOR). Memory 350 can store operating system 352, such as iOS, Darwin, RTXC, LINUX, UNIX, OS X, WINDOWS, or an embedded operating system such as VxWorks. Operating system 352 may include instructions for handling basic system services and for performing hardware dependent tasks. In some implementations, operating system 352 can include a kernel (e.g., UNIX kernel).

Memory 350 may also store communication instructions 354 to facilitate communicating with one or more additional devices, one or more computers and/or one or more servers, such as, for example, instructions for implementing a software stack for wired or wireless communications with other devices. Memory 350 may include graphical user interface instructions 356 to facilitate graphic user interface processing described in reference to FIGS. 1 and 2; sensor processing instructions 358 to facilitate sensor-related processing and functions; phone instructions 360 to facilitate phone-related processes and functions; electronic messaging instructions 362 to facilitate electronic-messaging related processes and functions; web browsing instructions 364 to facilitate web browsing-related processes and functions; media processing instructions 366 to facilitate media processing-related processes and functions; GNSS/Location instructions 368 to facilitate generic GNSS and location-related processes and instructions; camera instructions 370 to facilitate camera-related processes and functions described in reference to FIGS. 1 and 2; and other application 372 instructions. The memory 350 may also store other software instructions (not shown), such as security instructions, web video instructions to facilitate web video-related processes and functions and/or web shopping instructions to facilitate web shopping-related processes and functions. In some implementations, the media processing instructions 366 are divided into audio processing instructions and video processing instructions to facilitate audio processing-related processes and functions and video processing-related processes and functions, respectively.

In an embodiment, the taps, slide and lift gestures described in reference to FIGS. 1 and 2 are detected using a touch event model implemented in software on media capture device 300. An example touch event model is described in U.S. Pat. No. 8,560,975, entitled “Touch Event Model,” issued on Oct. 15, 2013, which patent is incorporated by reference herein in its entirety.

Each of the above identified instructions and applications can correspond to a set of instructions for performing one or more functions described above. These instructions need not be implemented as separate software programs, procedures, or modules. Memory 350 can include additional instructions or fewer instructions. Furthermore, various functions of the mobile device may be implemented in hardware and/or in software, including in one or more signal processing and/or application specific integrated circuits.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., SWIFT, Objective-C, C#, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API. In some implementations, an API call may report to an application the capabilities of a device running the application, such as input capability, output capability, processing capability, power capability, communications capability, etc.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

What is claimed is:

1. A method of capturing media comprising:
detecting, by a media capture device, a tap and hold gesture input directed to a media capture affordance displayed at a first location on a graphical user interface presented on a display screen of the media capture device;
responsive to the tap and hold gesture input, initiating, by the image capture device, a media capture session on the media capture device in an unlocked media capture session state;
responsive to the media capture device detecting a first lift gesture in which the tap and hold gesture input lifts from the first location on the graphical user interface during the media capture session, terminating, by the image capture device, the media capture session;
responsive to the media capture device detecting a slide gesture input in which the media capture affordance slides from the first location to a second location on the graphical user interface during the media capture session, changing, by the media capture device, the media capture affordance to a media capture lock affordance; and
responsive to the media capture device detecting a second lift gesture in which the slide gesture input lifts from the graphical user interface at the second location during the media capture session, transitioning, by the media capture device, the media capture session into a locked media capture session state.

2. The method of claim 1, wherein:
responsive to a tap gesture input directed to the media capture lock affordance, terminating the locked state or media capture session.

3. The method of claim 1, wherein changing the media capture affordance to the media capture lock affordance includes changing a size of the media capture affordance.

4. The method of claim 1, wherein changing the media capture affordance to the media capture lock affordance includes changing the size and a shape of the media capture affordance.

5. The method of claim 1, wherein changing the media capture affordance to the media capture lock affordance includes animating the media capture affordance to morph into the media capture lock affordance.

6. The method of claim 1, further comprising:
causing to display on the GUI a visual indicator indicating a direction for the slide gesture input on the GUI.

7. The method of claim 1, further comprising:
causing to display a first text message on the GUI before the slide gesture input, and displaying a second text message, different than the first text message, after the second lift gesture.

8. A media capture device comprising:
a touch screen;
one or more processors;
memory coupled to the one or more processors and configured to store instructions, which, when executed by the one or more processors, cause the one or more processors to perform operations comprising:
detecting, by the touch screen, a tap and hold gesture input directed to a media capture affordance displayed at a first location on a graphical user interface presented on the touch screen of the media capture device;
responsive to the tap and hold gesture input, initiating a media capture session on the media capture device in an unlocked media capture session state;
responsive to the touch screen detecting a first lift gesture in which the tap and hold gesture input lifts from the first location on the graphical user interface during the media capture session, terminating the media capture session;
responsive to the touch screen detecting a slide gesture input in which the media capture affordance slides from the first location to a second location on the graphical user interface during the media capture session, changing the media capture affordance to a media capture lock affordance; and
responsive to the touch screen detecting a second lift gesture in which the slide gesture input lifts from the graphical user interface at the second location during the media capture session, transitioning the media capture session into a locked media capture session state.

9. The media capture device of claim 8, wherein:
responsive to a tap gesture input directed to the media capture lock affordance, terminating the locked media capture session state.

10. The media capture device of claim 8, wherein changing the media capture affordance to the media capture lock affordance includes changing an appearance of the media capture affordance.

11. The media capture device of claim 8, wherein changing the media capture affordance to the media capture lock affordance includes changing the size and a shape of the media capture affordance.

12. The media capture device of claim 8, wherein changing the media capture affordance to the media capture lock affordance includes animating the media capture affordance to morph into the media capture lock affordance.

13. The media capture device of claim 8, the operations further comprising:
causing to display on the GUI a visual indicator indicating a direction for the slide gesture input on the GUI.

14. The media capture device of claim 8, the operations further comprising:
causing to display a first text message on the GUI before the slide gesture input, and displaying a second text message, different than the first text message, after the second lift gesture.

15. A non-transitory, computer-readable storage medium having instructions stored thereon that when executed by a media capture device, causes the media capture device to perform operations comprising:
detecting, by the media capture device, a tap and hold gesture input directed to a media capture affordance displayed at a first location on a graphical user interface presented on a display screen of the media capture device;
responsive to the tap and hold gesture input, initiating, by the image capture device, a media capture session on the media capture device in an unlocked media session capture state;
responsive to the media capture device detecting a first lift gesture in which the tap and hold gesture input lifts from the first location on the graphical user interface during the media capture session, terminating, by the image capture device, the media capture session;
responsive to the media capture device detecting a slide gesture input in which the media capture affordance slides from the first location to a second location on the graphical user interface during the media capture session, changing, by the media capture device, the media capture affordance to a media capture lock affordance; and
responsive to the media capture device detecting a second lift gesture in which the slide gesture input lifts from the graphical user interface at the second location during the media capture session, transitioning, by the media capture device, the media capture session into a locked media capture session state.

16. The non-transitory, computer-readable storage medium of claim 15, wherein:
responsive to a tap gesture input directed to the media capture lock affordance, terminating the locked state or media capture session.

17. The non-transitory, computer-readable storage medium of claim 15, wherein changing the media capture affordance to the media capture lock affordance includes changing an appearance of the media capture affordance.

18. The non-transitory, computer-readable storage medium of claim 15, wherein changing the media capture affordance to the media capture lock affordance includes animating the media capture affordance to morph into the media capture lock affordance.

19. The non-transitory, computer-readable storage medium of claim 15, further comprising:
causing to display on the GUI a visual indicator indicating a direction for the slide gesture input on the GUI.

20. The non-transitory, computer-readable storage medium of claim 15, further comprising:
causing to display a first text message on the GUI before the slide gesture input, and displaying a second text message, different than the first text message, after the second lift gesture.
